(19) United States
(12) Patent Application Publication
(10) Pub. No.: US 2010/0181195 A1
(43) Pub. Date: Jul. 22, 2010

(54) MICROFLUIDIC CHIP FOR AND A METHOD OF HANDLING FLUIDIC DROPLETS

(75) Inventor: Pablo Garcia Tello, Leuven (BE)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/667,276

(22) PCT Filed: Jun. 25, 2008
(86) PCT No.: PCT/IB08/52535

§ 371 Date: Dec. 30, 2009

(30) Foreign Application Priority Data
Jul. 3, 2007 (EP) 07111631.3
Jun. 25, 2008 (IB) PCT/IB2008/052535

(51) Int. Cl. B01J 19/08

(52) U.S. Cl. 204/450; 204/600; 204/643; 204/627

(57) ABSTRACT

A micro fluidic chip (100) for handling fluidic droplets (101), the micro fluidic chip (100) comprising a plurality of electrodes (103) being arranged in a Back End of the Line portion (104) of the microfluidic chip (100), and a control unit (106) adapted for controlling electric potentials of the plurality of electrodes (103) to generate electric forces for moving the fluidic droplets (101) along a predefined trajectory.

### FIELD OF THE INVENTION

The invention relates to a microfluidic chip.

Moreover, the invention relates to a method of handling fluidic droplets.

### BACKGROUND OF THE INVENTION

A biosensor may be denoted as a device that may be used for the detection of an analyte that combines a biological component with a physicochemical or physical detector component.

Such a biosensor may be operated with a droplet-based liquid handling and processing system, such as droplet-based sample preparation, mixing, and dilution on a microfluidic scale. More specifically, such systems may involve the manipulation of droplets by electrowetting-based techniques.

WO 2006/044966 discloses a single-sided electrowetting-on-dielectric apparatus, which is useful for microfluidic laboratory applications. The apparatus comprises a substrate, an array of control electrode elements disposed on the substrate, a first dielectric film disposed on, and overlaying, the substrate and the array of control electrode elements, at least one ground electrode element disposed on the first dielectric film, a second dielectric film disposed on, and overlaying, the first dielectric film and the at least one ground electrode element, and an electrowetting-compatible surface film disposed on the second dielectric film. A method of making the apparatus is also disclosed.

### OBJECT AND SUMMARY OF THE INVENTION

It is an object of the invention to accurately move fluidic droplets in a microfluidic device.

In order to achieve the object defined above, a microfluidic chip and a method of handling fluidic droplets according to the independent claims are provided.

According to an exemplary embodiment of the invention, a microfluidic chip for handling fluidic droplets (for instance a sample to be analyzed) is provided, the microfluidic chip comprising a plurality of electrodes being arranged in a Back End of the Line (BEOL) portion of the microfluidic chip, and a control unit (for instance an integrated circuit having processing capabilities) adapted for controlling electric potentials of the plurality of electrodes to generate electric forces for moving the fluidic droplets along a predefined trajectory (for instance along a specific predefined path on a surface of the microfluidic chip).

According to another exemplary embodiment of the invention, a method of handling fluidic droplets is provided, the method comprising controlling electric potentials of a plurality of electrodes being arranged in a Back End of the Line portion of a microfluidic chip to generate electric forces for moving the fluidic droplets along a predefined trajectory.

The term “Back End of the Line” (BEOL) or “Back End of the Line portion” may particularly denote a portion of an integrated circuit fabrication where active components (transistors, resistors, etc.) are interconnected with wiring on the wafer. BEOL generally begins when a first layer of metal is deposited on the processed wafer. It includes contacts, insulator, metal levels, and bonding sites for chip-to-package connections. Thus, particularly each structural component of an integrated circuit that is out of direct contact with the processed semiconductor substrate may be considered to belong to the BEOL.

In contrast to this, the term “Front End of the Line” (FEOL) or “Front End of the Line portion” may particularly denote a first portion of an integrated circuit fabrication where the individual devices (transistors, resistors, etc.) are patterned in the semiconductor. FEOL generally covers everything up to (but not including) the deposition of metal layers. Thus, particularly each structural component of an integrated circuit, which is part of the processed semiconductor substrate, may be considered to belong to the FEOL.

In other words, the Back End of the Line portion may be located directly on top of the Front End of the Line portion (in a spatial direction which corresponds to the manufacturing procedure).

The term “biosensor” may particularly denote any device that may be used for the detection of an analyte comprising biological molecules such as DNA, RNA, proteins, enzymes, cells, bacteria, virus, etc. A biosensor may combine a biological component (for instance capture molecules at a sensor active surface capable of detecting molecules) with a physicochemical or physical detector component (for instance a capacitor having a capacitance which is modifiable by a sensor event, or a layer having a redox potential which is modifiable by a sensor event, or a field effect transistor having a threshold voltage or a channel conductivity which is modifiable by a sensor event).

The term “microfluidic chip” may particularly denote that a microfluidic device is formed as an integrated circuit, that is to say as an electronic chip, particularly in semiconductor technology, more particularly in silicon semiconductor technology, still more particularly in CMOS technology. A monolithically integrated microfluidic chip has the property of very small dimensions thanks to the use of micro-processing technology, and may therefore have a large spatial resolution and a high signal-to-noise ratio particularly when the dimensions of the microfluidic chip or more precisely of components thereof approach or reach the order of magnitude of the dimensions of biomolecules.

The term “biological particles” may particularly denote any particles which play a significant role in biology or in biological or biochemical procedures, such as genes, DNA, RNA, proteins, enzymes, cells, bacteria, virus, etc.

The term “substrate” may denote any suitable material, such as a semiconductor, glass, plastic, insulator, etc. According to an exemplary embodiment, the term “substrate” may be used to define generally the elements for layers that underlie and/or overlie a layer or portions of interest. Also, the substrate may be any other base on which a layer is formed, for example a semiconductor wafer such as a silicon wafer or silicon chip.

The term “fluidic sample” may particularly denote any subset of the phases of matter. Such fluids may include liquids, gases, plasmas and, to some extent, solids, as well as mixtures thereof. Examples for fluidic samples are DNA containing fluids, blood, interstitial fluid in subcutaneous tissue, muscle or brain tissue, urine or other body fluids. For instance, the fluidic sample may be a biological substance. Such a substance may comprise proteins, polypeptides, nucleic acids, DNA strands, etc.

The term “fluidic droplet” may particularly denote a fluidic structure having a small volume such as in the order of magnitude of nanoliters (or less), microliters or milliliters (or more). A droplet may be a small volume of liquid, bounded partially or almost completely by free surfaces.

The term “electrowetting” may particularly denote a technique used to actuate microdroplets in a microfluidic device. Electrowetting may allow large numbers of droplets to be independently manipulated under direct electrical control without the use of pumps, valves or even fixed channels. The phenomenon of electrowetting can be understood in terms of the forces that result from the applied electric field. The fringing field at the corners of the electrolyte droplet tend to pull the droplet down onto the electrode, lowering the macroscopic contact angle, and increasing the droplet contact area.

According to an exemplary embodiment of the invention, a monolithically integrated microfluidic chip is provided in an electronic chip architecture comprising a (semiconductor) substrate in which first electronic components of the microfluidic chip are formed in the Front End of the Line portion. Above the Front end of the Line portion, a second stack of further layers and structures may be provided as the Back end of the Line portion. According to an exemplary embodiment of the invention, the active region for handling or manipulating fluidic droplets may be provided in the Back End of the Line portion. BEOL processing of a fluid actuation component may be advantageous due to the opportunity to spatially separate generation of fluid actuation signals and application of such signal to a microfluidic surface. Such architecture may be particularly advantageous when nanoelectrodes serving as fluid actuators can be manufactured sufficiently small. For example, such nanoelectrodes can be arranged in the FEOL with dimensions of 250 nm, 130 nm or less, so as to be capable to handle individual microdroplets or nanodroplets. This may allow to obtain a significant improvement of the accuracy of the fluid movement control, and may allow to handle very small volumes of sample in the order of microliters or nanoliters.

A specific advantage of using a BEOL portion for fluid actuation is that liquid components (such as an aqueous solution) of a fluidic sample may be brought in interaction with the BEOL layer and are properly separated by the BEOL stack from the below arranged FEOL stack so that there is no danger that FEOL components such as a gate region of a field effect transistor are contaminated or harmed by a fluidic liquid sample. Therefore, by performing the fluid actuation in the BEOL, it is possible to reliably decouple/isolate the liquid components from the microelectronic detection members provided below the BEOL layer in the FEOL layer. Materials that are provided in standard BEOL procedures, for instance copper, have advantageous properties to serve as BEOL electrodes, which may be connected to a buried FEOL transistor.

In contrast to exemplary embodiments of the invention, conventional approaches (such as the one of WO 2006/044966) exhibit limited utility with respect to droplet transport, as droplets tend to settle between adjacent electrodes due to equilibrium considerations. In order to avoid such limitations, embodiments of the present invention introduce critical innovations that allow the fabrication of smaller electrodes (for example 250 nm and below that size) and also reduce drastically the spacing between the electrodes so the droplets do not reach an equilibrium state between electrodes (spacing between electrodes can be even on the order of nanometers if desired). At the same time, embodiments of the present invention provide a fabrication method for the microfluidic chip that overcomes the complexity in the fabrication procedure of conventional chips.

Embodiments of the present invention therefore overcome the limitations found in conventional microfluidic chips that may lack accuracy regarding the movement of fluidic particles along a chip surface to a desired location and that employ more complex fabrication schemes.

As the field of molecular diagnostics is advancing towards the extended use of lab-on-chip technologies, it becomes possible to effectuate manipulations of fluids at the nanometer scale. Instead of driving a bulk fluid inside microchannels with mechanical or electrokinetic pumps, fluidic operations may be performed in droplet-based “digital” fluidic circuits. The entire biological analysis can then be performed in digital fluidic circuits. Such a concept may eliminate many problems, such as leakage and bounding, associated with channel-based microfluidics. Digital fluidic circuits may be made possible by the ability to manipulate fluidic droplets taking advantage of, for example, mediated surface wetting.

According to an exemplary embodiment of the invention, a microfluid processing device may be provided comprising a layer stack of a substrate layer, a substrate silicon oxide layer, a silicon nitride layer, a second silicon oxide layer, a layer comprising a first metal electrode and a second metal electrode, and a passivation layer (for instance made of silicon carbide). The electrodes may be at least partially be surrounded by a respective barrier layer (which may be made by Ta/TaN) and embedded in the second silicon oxide layer in such a way that at least a defined area of each electrode is exposed as a contact area adapted to process the microfluid.

Such a microfluidic device may be completely compatible with standard IC processing and may allow for a highly controlled manipulation of nanodroplets. It may further be easy to fabricate and may be fully compatible with standard back end CMOS processing. Furthermore, such a device may be highly scalable in the sense of electrodes having small critical dimensions. It may be easily integratable into a lab-on-chip platform. Furthermore, it may allow for an accurate electronic control of the droplet manipulation. Such a device may further have a high versatility, and may be applied, for instance, for microfluidic based systems and devices.

Next, further exemplary embodiments of the microfluidic chip will be explained. However, these embodiments also apply to the method of handling fluidic droplets.

The control unit may be adapted for controlling electric potentials of the plurality of electrodes in such a manner that, at a particular time, exactly two (or more, for instance four) adjacent ones of the plurality of electrodes are activated to provide electrical potentials having opposite polarity. In other words, only a small number of a large number of electrodes may be active at a specific time, so that for example a positive pole/positive terminal may be applied to one of the electrodes and a negative pole/negative terminal may be applied to the other one. This may force an electrically charged sample or droplet to move from one of the electrodes to the other one, depending on the polarity of the effective voltage and depending on the electric properties (such as electric charge, polarizability, etc.). During this control of the two electrodes, the remaining electrodes may remain at a floating potential, that is to say do not have to be controlled. Therefore, with very simple measures, an accurate transport of fluids along a predetermined path may be made possible.

The microfluidic chip may comprise a substrate, wherein the plurality of electrodes may be formed in the substrate, particularly in an upper portion thereof, in damascene technique. Damascene technique may denote a metal inlay technique for putting a metal such as silver or copper into a substrate and may be a very simple procedure for producing buried electrode portions, which may be combined with further electrode structures provided above and/or below the damascene electrode portions, using the damascene electrode portions as a bridge between lower lying integrated circuit components and a small dimensioned surface portion of the electrodes.

The microfluidic chip may have a barrier structure between the substrate and the plurality of electrodes. By such a barrier structure—which may be made of Ta/TaN—the micro fluidic chip may be manufactured with improved quality.

A patterned passivation layer may be provided on the plurality of electrodes. Each of the plurality of electrodes may comprise a first portion formed in the substrate and may comprise a second portion above the first portion and arranged in trenches of the passivation layer, wherein an exposed area of the second portion is smaller than a surface area of the first portion. Thus, a transfer from large electrode sizes in an interior of the substrate to small electrode sizes at an active surface may be performed, wherein the functionally active dimensions of the microfluidic chip for fluid actuation may dependent on the small dimensions of the near-surface portions. This may allow manufacturing miniature electrode structures to thereby allow to efficiently activating very small volumes of fluid.

Each of the plurality of electrodes may be addressed individually. In other words, an electric signal specific for a particular electrode may be applied only to this electrode. This may allow for an accurate adjustment of the path along which the droplets may be moved.

The microfluidic chip may comprise a substrate in and/or on which the plurality of electrodes may be arranged, and may comprise a cover, wherein a gap may be provided between the substrate and the cover for accommodating fluidic droplets. Thus, the sample of very small dimensions (for instance having volumes in the order of magnitude of microlitres or less) may be sandwiched between substrate and cover and may thus be prevented efficiently from evaporating, which is particularly important for the motion of individual droplets of a very small volume along a surface of a microfluidic chip. Thus, the cover may protect the sample and may prevent the sample from evaporating.

The microfluidic chip may be adapted as a single-sided electrowetting device or as a single-sided electrowetting-on-dielectric device. A single-sided electrowetting device has a direct contact between electrode material and the sample. In the case of a single-sided electrowetting-on-dielectric device, a dielectric layer may be provided between the electrodes and the fluid. CMOS processing is compatible with both schemes, single-sided electrowetting and single-sided electrowetting-on-dielectric technology.

The microfluidic device may be free of a counter electrode. A counter electrode may be used to make an electric connection to a fluid droplet so that the electric potential of the fluid droplet remains equal to the potential of the counter electrodes. Embodiments of the invention do not need such counter electrodes and can therefore be manufactured smaller and can be operated with less effort. This may allow for a simple construction. Beyond this, an electrical influence on the fluidic sample may have effect only from one (spatial) side of the fluidic sample. Therefore, also an optional cover element may be free of any electrode structures.

The plurality of electrodes may be arranged at an upper surface of a Back End of the Line portion of the microfluidic chip. Therefore, directly at the end of the integrated circuit, the fluidic actuator components may be located, which may simplify construction of the microfluidic device.

The microfluidic chip may comprise at least one intermediate metallization structure, particularly at least one intermediate copper structure, in the Back End of the Line portion, wherein the plurality of electrodes may be electrically coupled to a Front End of the Line portion of the microfluidic chip via the at least one intermediate metallization structure. By taking this measure, it may be possible to spatially separate the fluid separation components from buried low lying integrated circuit members for providing further electrical functions, such as electrical control functions.

An exposed surface of at least a part of the plurality of electrodes may have dimensions of less than 300 nm. Thus, electrodes of very small dimensions may be manufactured which may be the basis for the handling of fluids in very small volumes.

The microfluidic chip may be manufactured in CMOS technology. CMOS technology, particularly the latest generations thereof, allow to manufacture structures with very small dimensions so that (spatial) accuracy of the device will be improved by implementing CMOS technology particularly in the Front End of the Line. A BiCMOS process in fact is a CMOS process with some additional processing steps to add bipolar transistors.

The microfluidic chip device may be monolithically integrated in a semiconductor substrate, particularly comprising one of the group consisting of a group IV semiconductor (such as silicon or germanium), and a group III-group V semiconductor (such as gallium arsenide).

The microfluidic chip may comprise a plurality of wells, each of the plurality of wells being arranged above a corresponding one of the plurality of electrodes and being adapted to accommodate a fluidic droplet at least partially. Thus, above the electrodes, a recess such as a dip in a surface may be provided which may receive a droplet being moved along a path of well/electrode pairs. Such a groove arrangement may provide the droplet with a stable support at a specific electrode so that the droplet may be securely moved from one well/electrode pair to the next.

The microfluidic device may be (at least a part of) a sensor device, a sensor readout device, a lab-on-chip, an electrophoresis device, a sample transport device, a sample mix device, a sample washing device, a sample purification device, a sample amplification device, a sample extraction device or a hybridization analysis device. Particularly, the microfluidic device may be implemented in any kind of life science apparatus.

According to an exemplary embodiment of the invention, an electrowetted device for the manipulation of nanodroplets may be provided. Particularly, a microfluidic actuating device may be provided which can be fabricated according to a standard semiconductor manufacturing techniques and can for example be integrated in a normal CMOS flow where one or more additional sensors may be placed. Moreover, this may allow for the fabrication of ultra-small electrodes and therefore electrodes that can be very close to each other and actuate the fluid very efficiently.

The direction of actuation (movement) of the fluid may depend on the control of the electrodes, particularly on electrode shape and separation and on the manner in which an AC (alternating current) field applied to the electrodes is switched on and off.

Thus, an arrangement of two or more electrodes may be provided which electrodes may be equally spaced helping to create a regular and uniform convective ring that drags the fluid uniformly. The surface of such a microfluidic device may be flat to avoid friction forces between the fluid and the surface. The shape of the electrodes may be rectangular, or may have an alternative shape such as a trapeze shape. Embodiments of the invention are not restricted on a size of a photoresist patterning (that is to say an opening in a passivation layer above the metal electrodes embedded in the substrate), so that conventional back end CMOS processing may be used. Exemplary electrode metal materials are aluminium or copper. A barrier layer may be foreseen in a trench etched in an electrically insulating layer in which subsequently copper material is deposited; it may be mentioned that any barrier material that is compatible with CMOS fabrication may be used.

An advantageous property of electro-osmosis is moving of the fluid itself by a momentum transfer to it, and the fluid drags whatever is immersed in it. This is in contrast to electrophoresis that is dragging a particle through a fluid. Embodiments of the invention are compatible with a wide variety of specific fluids with biomolecules to be actuated, for example DNA in a corresponding buffer solution or proteins in a suitable buffer solution.

Embodiments of the invention provide a microfluidic device avoiding any complexity, particularly avoiding the settlement of the drops between electrodes. For this purpose, the use of back end semiconductor processing may be implemented, which may allow for the fabrication of smaller electrodes (for example 250 nm and below that size), and may allow to reduce significantly the spacing between electrodes so that droplets do not reach an equilibrium state between neighboured electrodes (spacing can be in the order of magnitude of nanometers, if desired).

According to an exemplary embodiment, a drop may be moved by selectively biasing pairs of adjacent electrodes so that they function selectively as drive or reference electrodes by allowing the potential of all immediately surrounding electrodes to float. This may be denoted as a single-side electrowetting device. In this sense, there is no need to provide continuous ground electrodes. Besides, the droplet can be confined within a covered microchannel to avoid drop evaporation, if desired.

According to an exemplary embodiment of the invention, an electrowetting system may be fabricated in a CMOS platform, which allows the driving and floating electrodes to be controlled by suitable CMOS electronic design for it.

The phenomenon of electrowetting can be understood in terms of the forces that result from an applied electric field between a first electrode and a second electrode and a droplet sitting in one of them (for instance in the first electrode). The fringing fields at the corners of the electrolyte droplet tend to pull the droplet down onto the second electrode, lowering the microscopic contact angle, and increasing the droplet contact area. The net result may be a displacement of the droplet from one electrode to another. Contact angles of liquid droplets on the electrode surface can be controlled by electric potentials according to the Lippmann-Young equation:

$$cos θ ( V ) - cos θ ( 0 ) = \frac{ɛ}{2 {γ}_{LV} t} {V}^{2}$$

In this equation, θ(V) is the contact angle under the electric potential V, γ_{LV} is the surface tension at the liquid vapour interface, and ∈ and t are the permittivity and the thickness of the insulating layer, respectively. In case of an alternating current (AC) voltage is applied, V is replaced by the route mean square (RMS) voltage.

According to an exemplary embodiment, a method to fabricate a device may be provided that is absolutely compatible with standard IC processing and that allows for the highly controlled manipulation of nanodroplets. Particularly, a device for microfluidic manipulation may be provided. More particularly, a method to fabricate nanoelectrodes may be provided that is compatible with standard IC processing and that allows for the making of a microfluidic actuating-device to be used in biomolecular manipulation.

For any method step, any conventional procedure as known from semiconductor technology may be implemented. Forming layers or components may include deposition techniques like CVD (chemical vapour deposition), PECVD (plasma enhanced chemical vapour deposition), ALD (atomic layer deposition), or sputtering. Removing layers or components may include etching techniques like wet etching, plasma etching, etc., as well as patterning techniques like optical lithography, UV lithography, electron beam lithography, etc.

Embodiments of the invention are not bound to specific materials, so that many different materials may be used. For conductive structures, it may be possible to use metallization structures, silicide structures or polysilicon structures. For semiconductor regions or components, crystalline silicon may be used. For insulating portions, silicon oxide or silicon nitride may be used.

The biosensor may be formed on a purely crystalline silicon wafer or on an SOI wafer (Silicon On Insulator).

Any process technologies like CMOS, BIPOLAR, and BICMOS may be implemented.

The aspects defined above and further aspects of the invention are apparent from the examples of embodiment to be described hereinafter and are explained with reference to these examples of embodiment.

### BRIEF DESCRIPTION OF THE DRAWINGS

The invention will be described in more detail hereinafter with reference to examples of embodiment but to which the invention is not limited.

FIG. 1 to FIG. 6 show microfluidic chips according to exemplary embodiments of the invention.

FIG. 7 to FIG. 13 show layer sequences obtained during the manufacture of a microfluidic chip according to an exemplary embodiment of the invention.

### DESCRIPTION OF EMBODIMENTS

The illustration in the drawing is schematical. In different drawings, similar or identical elements are provided with the same reference signs.

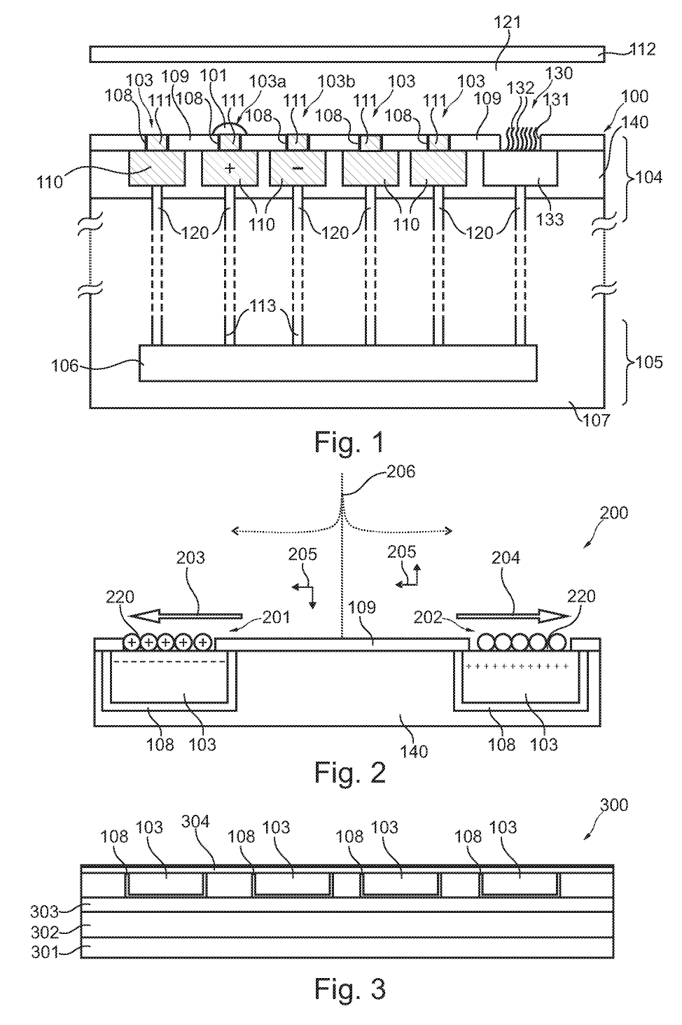

In the following, referring to FIG. 1, a microfluidic chip 100 for handling fluidic droplets 101 according to an exemplary embodiment of the invention will be explained.

The device 100 comprises a silicon substrate 107 in which a plurality of components are integrated. In an upper portion of the device 100, electrodes 103 are formed in an electrically insulating layer 140 above the silicon substrate 107. However, the electrically insulating layer 140 and the silicon substrate 107 may be denoted as a “substrate”.

The microfluidic chip 100 comprises a Front End of the Line portion 105 and a Back End of the Line portion 104, wherein the electrodes 103 are formed in the Back End of the Line portion 104.

In the Front End of the Line portion 105, a control unit 106 is provided as an integrated circuit and which is adapted for controlling electric potentials of the plurality of electrodes 103 to selectively generate electric forces for moving the fluidic droplets 101 along a predefined trajectory, namely in a horizontal direction from left to right according to FIG. 1.

Alternatively, the control unit 106 may also be formed apart from the microfluidic chip 100 in a separate device.

The control unit 106 is adapted for controlling electric potentials of the plurality of electrodes 103 in such a manner that, in the scenario shown in FIG. 1, one electrode 103a has a positive polarity, and another electrode 103b has a negative polarity, and all remaining electrodes 103 are floating, that is to say do not have any defined electric potential. Therefore, in the present embodiment, an electric field is generated between the electrodes 103a, 103b which are positively and negatively charged, respectively, so that the droplet 101, when being positively charged, is transported under the influence of electric forces from the positively charged electrode 103a to the negatively charged electrode 103b. Thus, according to the architecture of FIG. 1, a transport of fluidic droplets 101 in the microliter regime is possible.

The electrodes 103 comprise a damascene portion 110 which are integrated within the layer 140 in damascene technique, and comprise an exposed portion 111 (exposed to the sample chamber in which the fluidic droplet 101 moves) filled in trenches formed in a passivation layer 109 to be in electrically conductive connection with the respective damascene portions 110. Beyond this, a barrier portion 108 is formed in each of the trenches in the passivation layer 109 and can be made of Ta/TaN. The portions 110 and 111 of the electrodes 103 are made of copper material.

Via buried electrical connections 120 (which may be constituted of several structures in different metallization layers), each of the plurality of electrodes 103 may be addressed individually.

The microfluidic device 100 comprises an elevated cover element 112, wherein a gap 121 is formed as a sample chamber between the surface of the passivation layer 109 and the cover 112. Within this gap 121, the fluid droplets 101 are accommodated and are protected against external influences and against evaporation.

The microfluidic chip 100 is formed in CMOS technology, and is adapted as a biosensor chip, that is to say is made of biocompatible materials allowing biological samples such as the droplet 101 comprising proteins or DNA to be transported and analyzed in the microfluidic device 100.

With the device 100, microfluidic actuation of the droplet 101 may be performed. For this purpose, the fluidic droplet 101 may be moved from the left-hand side to the right-hand side in FIG. 1 and may be brought, for instance, in interaction with other fluidic droplets during this move (for instance for mixing, merging, or triggering a reaction). For example, chemical or biochemical reactions, lysing, polymerase chain reaction (PCR), washing steps, etc. may be performed to manipulate or analyze the fluidic sample 101. At the end of such a procedure, the fluidic sample 101 may be transported to a sensing portion 130 for sensing/detection. The sensing portion 130 comprises a sensing pocket 131 in which pluralities of capture molecules 132 are immobilized. When molecules being complementary to the capture molecules 132 are included in the fluidic droplet 101, hybridization events may occur and a corresponding electrical property in an environment of the sensor pocket 130 may be changed, thereby generating a change in an electrical potential of a sensing electrode 133 which can be detected as well by the control unit 106.

The biosensor chip 100 is based on the phenomenon that the capture molecules 132 immobilized on the surface of the sensing electrode 132 may selectively hybridize with target molecules in the fluidic sample 101, for instance when an antibody-binding fragment of an antibody or the sequence of a DNA single strand as a capture molecule 132 fits to a corresponding sequence or structure of a target molecule of the fluidic sample 101. When such hybridization or sensor events occur at the sensor surface, this may change the electrical properties of the surface, which may be detected as a sensor event by the control unit 106.

In the following, referring to FIG. 2, a microfluidic chip 200 according to another exemplary embodiment of the invention will be explained.

Before going into more detail regarding to FIG. 2, AC electro-osmosis (ACEO) will be explained.

When a potential is applied to an electrode 103, the field causes charges 201, 202 to accumulate on the surface of the electrodes 103, which may change to the charge density near the surface and may form an electric double layer. This process may be called electrode polarization. The electric double layer interacts with the tangential component of the electric field. A net force may be generated on the double layer and causes fluid motion, as can be taken from FIG. 2.

In an alternating electric field, both the sign of the charges 201, 202 in the electric double layer and the direction of the tangential component of the electric field change. Therefore, the direction of the resulting force on the fluid remains the same when the polarity changes.

The electro-osmotic velocity v on the surface of parallel electrodes 103 may be:

$$〈 v 〉 = \frac{1}{8} \frac{{ɛV}_{0}^{2} {Ω}^{2}}{μ {r ( 1 + {Ω}^{2} )}^{2}}$$

where ∈ is the permittivity of the electrolyte, V₀ is the potential applied to the electrodes 103, μ is the viscosity of the electrolyte, and r is the distance from the centre of the electrode gap to the point of interest. The non-dimensional frequency Ω is given by:

$$Ω = \frac{π}{2} ω r \frac{ɛ}{σ} κ$$

where ω is the angular frequency of the applied electric field, σ is the conductivity of the electrolyte, and κ is the reciprocal Debye length of the electric double layer. The bulk fluid motion driven by AC electro-osmosis depends on the geometry of the electrodes 103 and can be calculated numerically. Numerical simulations predict circulations of the fluid on top of the electrodes 103.

Coming back to FIG. 2, an AC electro-osmosis system is explained, wherein reference numerals 203 and 204 denote a Coulomb force, and reference numerals 201, 202 denote induced charge in the double layer. A tangential component of the electric field is denoted with reference numeral 205, and reference numeral 206 illustrates direction and velocity of the fluid flow.

Next, referring to FIG. 3, a microfluidic chip 300 according to another exemplary embodiment of the invention will be explained.

The device 300 comprises a silicon substrate 301, a silicon oxide layer 302, a silicon nitride layer 303, a Ta/TaN barrier layer 108, a copper electrode 103 and a very thin silicon carbide layer 304.

In order to manufacture the microfluidic chip 300, all fabrication only involves standard Back End of the Line (BEOL) processing used in, for example, damascene techniques. The silicon carbide layer 304 is used in this embodiment to allow to perform electrowetting-on-dielectric (EWOD).

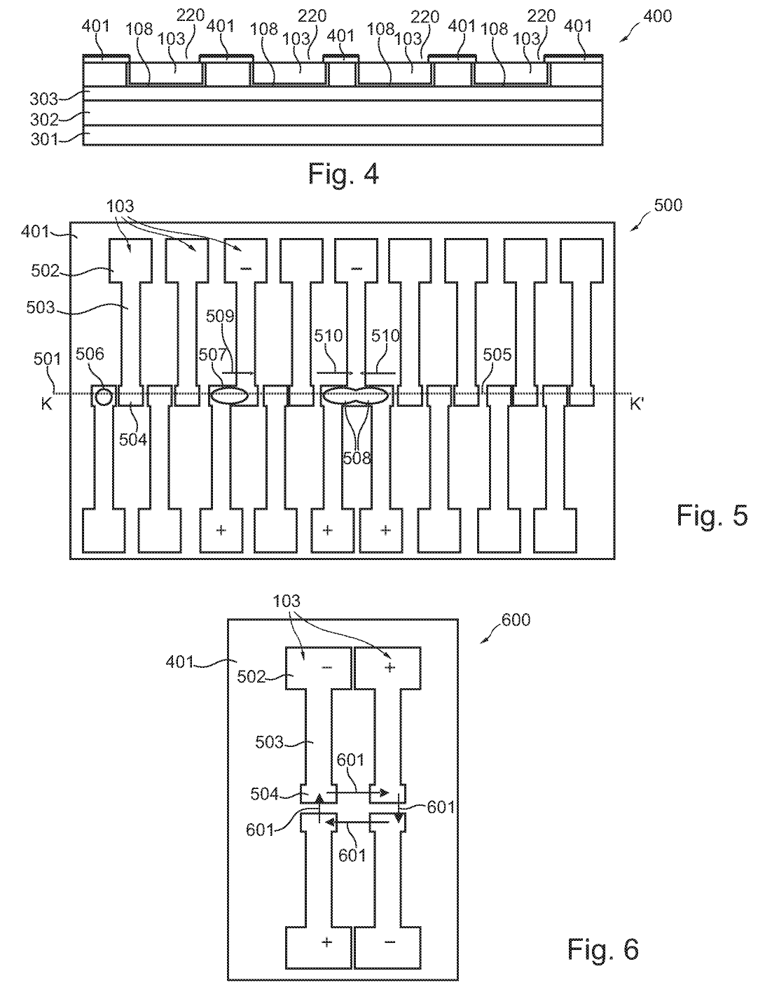

In contrast to this, a microfluidic chip 400 according to another exemplary embodiment of the invention shown in FIG. 4 comprises a silicon carbide layer 401 being patterned allowing to perform electrowetting (EW). FIG. 4 shows a cross-section along a line K-K′ of FIG. 5.

FIG. 5 thus shows a plan view of the microfluidic device 400.

A droplet 506 on the left-hand side is injected in the device 400 via an inlet 501 included in the package. A droplet 507 in the centre part is an example of a controlled drop movement, moving along a direction indicated by an arrow 509. On a right-hand side of FIG. 5, two drops 505 are shown which are presently merged by corresponding forces, as indicated by arrows 510 in FIG. 5.

As can be taken from FIG. 5, each of the electrodes 103 comprises a thick contact portion 502 via which an electric signal may be applied to the corresponding electrode 103, comprises a thin intermediate portion 503 and comprises a rectangular end portion 504 having a smaller area than the thick contact portion 502. The portions 504 of the various electrodes 103 are aligned to form a fluid motion trajectory 505. The fluid motion trajectory 505 is arranged perpendicular to an extension of the oblong intermediate portions 503. The contacting portions 502 have a larger area than the trajectory portions 504, and are therefore arranged in an alternating geometric manner on the different sides of the fluid motion trajectory 505.

As can be taken from FIG. 5, some of the electrodes 103 are negatively charged, others are positively charged to thereby initiate the drop movement of the droplet 507 in the middle portion, or the merging movement of the two droplets 508 on the right-hand side.

FIG. 6 shows a plan view of a microfluidic chip 600 according to another exemplary embodiment of the invention.

Also in this embodiment, each of the electrodes 103 comprises a contact portion 502, an intermediate portion 503 and a fluid contact portion 504. FIG. 6 shows an arrangement in which a fluid circulation, that is to say a circular fluid motion along the arrows 601 of FIG. 6, is initiated. Each of the electrodes 103 in FIG. 6 is addressed individually.

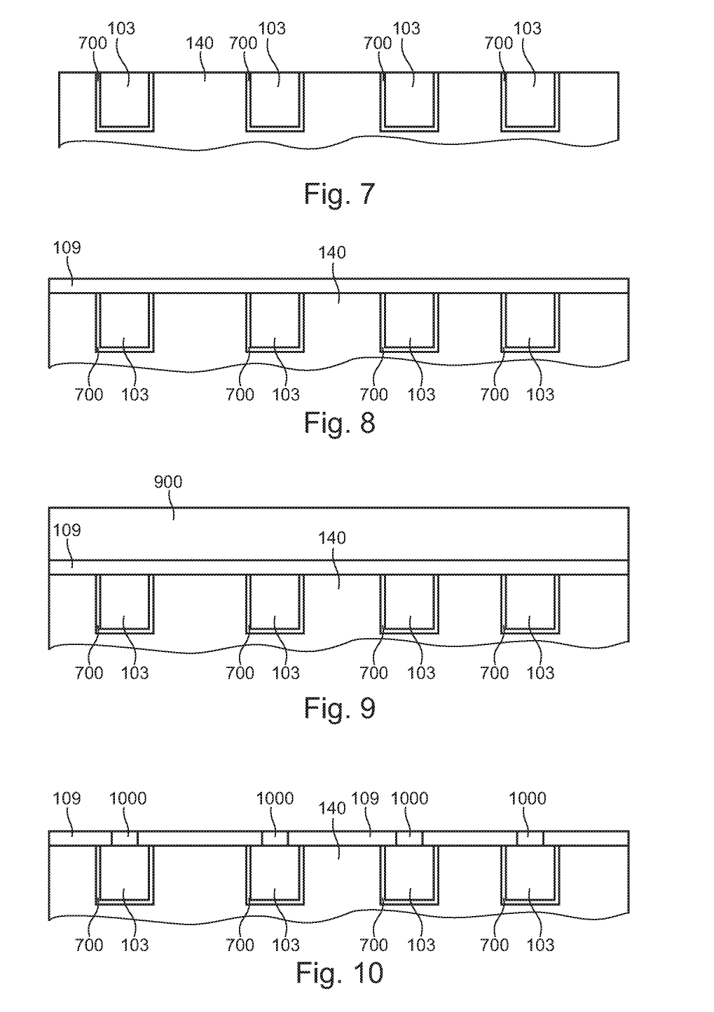

In the following, referring to FIG. 7 to FIG. 13, a process of manufacturing a microfluidic device according to an exemplary embodiment of the invention will be explained.

In order to obtain the layer sequence shown in FIG. 7, a Ta/TaN barrier plus a copper seed 700 (in the context of BEOL processing) are formed in trenches of a layer 140. The lined trenches are then filled with copper material to form the electrodes 103.

In order to obtain the layer sequence shown in FIG. 8, a passivation layer 109 is deposited on the layer sequence shown in FIG. 7.

After that, as can be taken from the layer sequence shown in FIG. 9, a photoresist layer 900 is deposited on the surface of the layer sequence shown in FIG. 8.

In order to obtain the layer sequence shown in FIG. 10, the photoresist layer 900 is patterned, and the passivation layer 109 is etched to form trenches 1000. The photoresist 900 is removed, for instance by stripping.

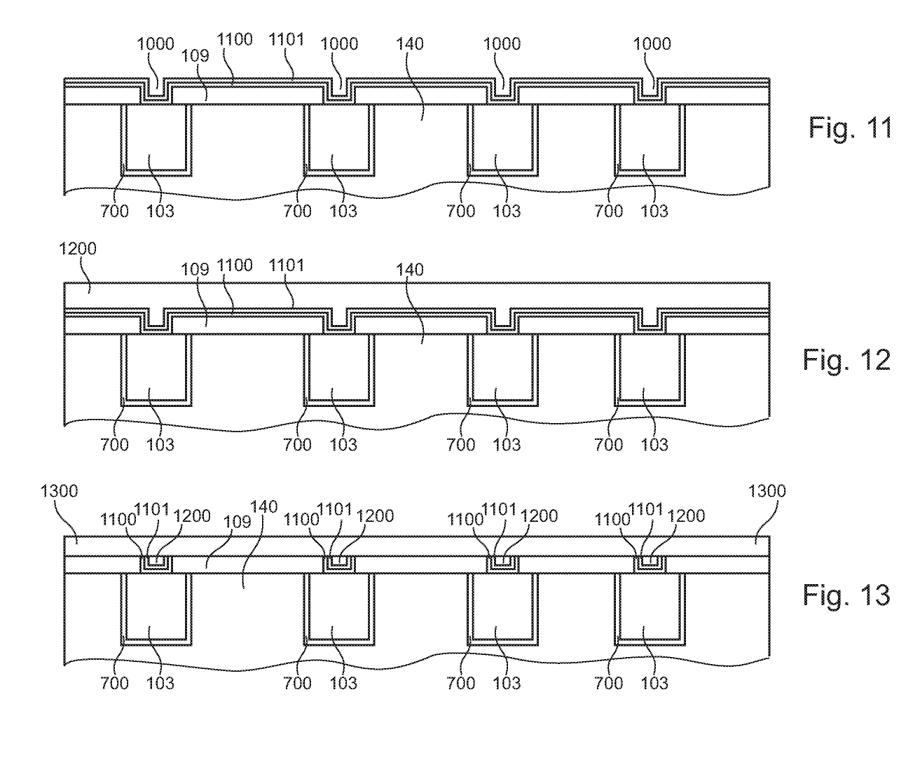

In order to obtain the layer sequence shown in FIG. 11, a Ta/TaN barrier 1100 and a copper seed structure 1101 are deposited on the layer sequence shown in FIG. 10.

In order to obtain the layer sequence shown in FIG. 12, a copper plating procedure is performed, in order to generate a copper structure 1200.

In order to obtain the layer sequence shown in FIG. 13, the copper layer 112 is partially removed by performing a metal CMP (“chemical mechanical polishing”), followed by an organic BTA layer 1300 deposition for electrode isolation.

In FIG. 13, each of the electrodes 103 runs in a direction perpendicular to the paper plane. Each one of the electrodes 103 can be individually addressed (with positive or negative voltages) using for example bond pads associated to each one of them and by means of internal (meaning on-chip) or external electronics. The bond pads can be fabricated for example at each one of the ends of the copper electrodes 103 by standard CMOS processing. The electrode array can be embedded in a microfluidic channel as being a critical part of it and subsequently packaged into a general purpose lab-on-chip. By taking this measure, the quality of the generated microfluidic chip may be significantly improved.

Finally, it should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The words “comprising” and “comprises”, and the like, do not exclude the presence of elements, materials or steps other than those listed in any claim or the specification as a whole. The singular reference of an element does not exclude the plural reference of such elements and vice-versa. In a device claim enumerating several means, several of these means may be embodied by one and the same item of software or hardware. The mere fact that certain measures are recited in mutually different dependent claims does not indicate that a combination of these measures cannot be used to advantage.

1. A microfluidic chip for handling fluidic droplets, the microfluidic chip comprising
a plurality of electrodes being arranged in a Back End of the Line portion of the microfluidic chip;
a control unit adapted for controlling electric potentials of the plurality of electrodes to generate electric forces for moving the fluidic droplets along a predefined trajectory.

2. The microfluidic chip according to claim 1, adapted to perform a liquid and/or molecular transport of the fluidic droplets parallel or perpendicular to an alignment of the plurality of electrodes.

3. The microfluidic chip according to claim 2, adapted to perform the liquid and/or molecular transport of the fluidic droplets using a technique of one of the group consisting of dielectrophoresis, electro-osmosis, and electrophoresis.

4. The microfluidic chip of claim 1, wherein the control unit is adapted for controlling electric potentials of the plurality of electrodes in such a manner that, at a particular time, two adjacent ones of the plurality of electrodes are activated to provide electrical potentials having opposite polarity.

5. The microfluidic chip of claim 4, wherein the control unit is adapted for controlling electric potentials of the plurality of electrodes in such a manner that, when the two adjacent ones of the plurality of electrodes are activated, remaining electrodes have a floating electric potential.

6. The microfluidic chip of claim 1, comprising a substrate, wherein the plurality of electrodes is formed in the substrate in damascene technique.

7. The microfluidic chip of claim 6, comprising a barrier structure between the substrate and the plurality of electrodes.

8. The microfluidic chip of claim 1, comprising a patterned passivation layer on the plurality of electrodes, wherein each of the plurality of electrodes comprises a first portion formed in the substrate and comprises a second portion above the first portion and in trenches of the passivation layer, wherein an exposed area of the second portion is smaller than a surface area of the first portion.

9. The microfluidic chip of claim 1, wherein each of the plurality of electrodes is addressable individually.

10. The microfluidic chip of claim 1, comprising a substrate in and/or on which the plurality of electrodes are arranged, and comprising a cover, wherein a gap is provided between the substrate and the cover for accommodating fluidic droplets.

11. The microfluidic chip of claim 10, wherein the cover is free of electrodes.

12. The microfluidic chip of claim 1, adapted as a single-sided electrowetting device or as a single-sided electrowetting-on-dielectric device.

13. The microfluidic chip of claim 1, wherein the microfluidic chip is free of a counter electrode.

14. The microfluidic chip of claim 1, wherein the plurality of electrodes are arranged at an upper surface of a Back End of the Line portion the microfluidic chip.

15. The microfluidic chip of claim 1, comprising at least one intermediate metallization structure, particularly at least one intermediate copper structure, in the Back End of the Line portion, wherein the plurality of electrodes is electrically coupled to a Front End of the Line portion of the microfluidic chip via the at least one intermediate metallization structure.

16. The microfluidic chip of claim 1, wherein an exposed surface of at least a part of the plurality of electrodes has a dimension of less than about 300 nm.

17. The microfluidic chip according to claim 1, manufactured in CMOS technology.

18. The microfluidic chip according to claim 1, being monolithically integrated in a semiconductor substrate, particularly comprising one of the group consisting of a group IV semiconductor, and a group III-group V semiconductor.

19. The microfluidic chip according to claim 1, adapted as a biosensor chip.

20. The microfluidic chip according to claim 1, comprising a plurality of wells, each of the plurality of wells being arranged above a corresponding one of the plurality of electrodes and being adapted to accommodate a fluidic droplet at least partially.

21. A method of handling fluidic droplets, the method comprising
controlling electric potentials of a plurality of electrodes being arranged in a Back End of the Line portion (104) of a microfluidic chip to generate electric forces for moving the fluidic droplets along a predefined trajectory.

22. The microfluidic chip of claim 1, wherein an exposed surface of at least a part of the plurality of electrodes has a has a dimension of less than about 200 nm.

23. The microfluidic chip of claim 1, wherein an exposed surface of at least a part of the plurality of electrodes has a has a dimension of less than about 100 nm.
